(19) United States
(12) Patent Application Publication
(10) Pub. No.: US 2021/0065470 A1
(43) Pub. Date: Mar. 4, 2021

(54) METHOD FOR AUTOMATICALLY GENERATING A DOCUMENTATION ENTRY

(71) Applicant: 365FarmNet Group KGaA mbH & Co. KG, Harsewinkel (DE)

(72) Inventor: Robert KASSECK, Berlin (DE)

(73) Assignee: 365FarmNet Group KGaA mbH & Co. KG, Harsewinkel (DE)

(21) Appl. No.: 16/998,064

(22) Filed: Aug. 20, 2020

(30) Foreign Application Priority Data
Aug. 28, 2019 (DE) 102019123092.6

(51) Int. Cl. G07C 5/02; G06F 16/23; G06Q 30/02

(52) U.S. Cl. CPC G07C 5/02; G06Q 30/0283; G06F 16/2379

(57) ABSTRACT

A method for automatically generating a documentation entry in which work of an agricultural work machine is documented in the documentation entry. Work data are acquired during performance of the work, wherein a location determining system records a movement track of the work machine during the performance of the work. The work data comprise at least the movement track. The performed work is automatically associated with a class based on the work data, and the class of the performed work is automatically inserted in the documentation entry.

### CROSS-REFERENCE TO RELATED APPLICATIONS

This application claims priority under 35 USC 119 of German Application No. DE 10 2019 123 092.6, filed on Aug. 28, 2019, the disclosure of which is herein incorporated by reference.

### BACKGROUND OF THE INVENTION

The present invention is concerned with the automatic generation of a documentation entry for the work of an agricultural work machine. Agricultural work machines are, in particular, self-propelled agricultural work machines such as tractors, combine harvesters and forage harvesters.

The documentation of work processes in agriculture is becoming increasingly important. On one hand, this is a result of the requirement for traceability of performed tasks within the scope of contracting and in large-scale operations with a number of employees. On the other hand, a requirement for documentation also results from the growing legal obligation of the farmer to provide documentary proof particularly in the area of fertilizing and plant protection.

Documentation systems which store some work data and which make documentation easier for the operator of the work machine are known from the prior art. However, the operator must still document much data manually, which is cumbersome and subject to error.

A method for storing data of a work process of an agricultural machine is known from DE102017105493A1.

An electronic time management system which automatically documents time as well as traveled area is known from DE102014108644A1.

### SUMMARY OF THE INVENTION

It is the object of the invention to further automate the generation of a documentation entry for agricultural work machines.

This object is met by a method for automatically generating a documentation entry, wherein work of an agricultural work machine is documented in the documentation entry, wherein work data are acquired during performance of the work, wherein a location determining system records a movement track of the work machine during the performance of the work, wherein the work data comprise at least the movement track, wherein the performed work is automatically associated with a class based on the work data, and the class of the performed work is automatically inserted in the documentation entry.

The location determining system is preferably a smartphone which is carried by the operator of the work machine during the work. Alternatively, the location determining system can be installed in or on the work machine. Smartphones often comprise a receiver for a satellite navigation system with which the current position can be determined. The smartphone can also carry out further steps of the method. The smartphone can associate the performed work with a class, for example. To this end, a plurality of classes and criteria for associating the work with a class can be stored on the smartphone.

Generally, the steps of the method can be carried out by means of different tools. The association of the performed work with a class can be carried out, for example, directly by the smartphone or by a computer installed in the work machine. Alternatively, the work data can also be stored and the association carried out on a computer after the work is performed. The work data are preferably transmitted to a computer system during the work, and the association is carried out in the computer system. The transmission of the work is preferably carried out at least partially as a radio transmission. The computer system is preferably a documentation system. The computer system preferably generates the documentation entry.

The movement track preferably comprises a sorted list of a plurality of points. Each point of the movement track indicates a location. Since fields can often be worked in strips or in spirals, the working width of the work machine can be determined from the movement track. The class of work can be deduced from the working width. In this way, the performed work can be associated with a class based on the work data, particularly based on the movement track.

The class indicates the type of work performed. Examples of classes are, for example, soil cultivation, sowing, maintenance, crop protection, fertilization, deep tillage, harvesting, irrigation, seedbed preparation, pasture cutting, and the like. A plurality of classes is preferably predefined. Criteria for analyzing work data are preferably predefined for associating the performed work with a class. Classes can also be changed and redefined by the user. Criteria for the association can likewise be changed and redefined by the user.

In one embodiment, the documentation entry is posted in a documentation acquisition system. As a result of posting in the documentation acquisition system, the information contained in the documentation entry is stored permanently and can be recalled when necessary. The posting can take place automatically directly after the documentation entry is generated or after manual confirmation. It is also possible to manually correct or amend the documentation entry prior to posting.

In a preferred embodiment, the work data comprise information about the time and duration of the performed work. For example, the information can be in the form of starting time and ending time. The duration of the work can then be deduced from the difference in times. The information can be utilized in particular when associating with the class. For example, some work is only carried out at certain times of the year.

In one embodiment, information contained in the work data is at least partially inserted in the documentation entry. In so doing, the information may be inserted into the documentation entry directly or via processing. Information about the time of the work is preferably inserted directly in the documentation entry. The worked field is preferably determined from the movement track, and a name and/or an ID of the worked field is added to the documentation entry.

In a preferred embodiment, when generating the documentation entry, data from a database are inserted into the documentation entry and/or data from the database are used for the association. For example, the coordinates of a field can be provided in the database together with an ID of the field and/or a name of the field. If there is a minimum number or a minimum proportion of points of the movement track located within the coordinates of a field, the ID and/or the name of the field is inserted in the documentation entry. Information about the crop grown in the field can also be present in the database. This information can be inserted directly in the documentation entry and also utilized for associating.

In a further embodiment, information from past documentation entries is present in the database. Information from past documentation entries may relate in particular to the same field. If work previously performed in the field is known from a past documentation entry, this information can be utilized for association. Information from past documentation entries may also relate to the same work machine. If the last work performed by the work machine is known, this information can be utilized for association.

In a preferred embodiment, the database contains information about:
the positions for a plurality of fields, and/or
a locality category for a plurality of locations, and/or
the type of crop grown in at least one field, and/or
the class of at least one job previously performed in at least one field.

The positions of the fields are preferably stored as coordinates of a global satellite navigation system. Accordingly, the location determined by the location determining system can very easily be associated with a field. Examples of locality categories are field, road, farm, repository, or the like. Accordingly, the location determined by the location determining system can be associated with a locality category. The locality category can be inserted in the documentation entry and/or utilized for associating.

In a preferred embodiment, the work data comprise information about mounted implements connected to the work machine, and the information is added to the documentation entry. Information about mounted implements connected to the work machine can be exchanged between the work machine and the mounted implement, for example, via a communications link, and added to the work data by the work machine. Alternatively, a radio beacon, also known as beacon, can be arranged at the mounted implement. The radio beacon transmits an identification, preferably via Bluetooth, which is detected by the smartphone of the operator and is added to the work data. The identification provides information via which the type of mounted implement can be determined. For example, further information may be contained in a database for each identification. Radio beacons can also be arranged at repositories or other places. The identification of the radio beacons can be associated with a locality category via information in the database.

In one embodiment, an amount of consumed work materials is determined from the work data, and the consumed amount is added to the documentation entry. Work materials include, for example, crop protection means, fertilizer, fuel and the like. Consumption is preferably detected by the work machine or by the mounted implement. Fuel can be, for example, gasoline, diesel or electricity.

In a preferred embodiment, the work data comprise information about the movement speed of the work machine at a plurality of points of the movement track. Preferably, a time is associated with a plurality of points of the movement track. The speed of the work machine between two points can be determined from the differences between the locations of the two points and the differences between the times of the two points. The movement speed is preferably associated with one of the two points. Every point is preferably stored with a timestamp. The timestamp preferably indicates the time at which the location was determined. A sorting of the points is determined by the timestamp.

In a further embodiment, the work data comprise information about a respective orientation of the work machine to a plurality of points of the movement track. The orientation can be detected directly, for example, via an electronic compass in the smartphone, or can be derived indirectly from the movement track. The work machine normally moves in a forward direction so that the orientation is given by the difference vector between two adjacent points of the movement track. When the points of the movement track contain time information, the rotational speed can also be determined from the movement track. In this case, information about the rotational speed is already contained in the work data. Alternatively, the rotational speed can be determined, for example, via a gyroscope, preferably in the smartphone. The rotational speed can then be added to the work data, preferably with timestamps.

In an embodiment, a monetary valuation of the performed work is carried out, and the monetary valuation is added to the documentation entry. In the monetary valuation, the work time, the type of work machines and/or the consumed work materials are evaluated.

The invention also comprises a system for automatically generating a documentation entry about the work performed by an agricultural work machine. The system acquires work data while the work is being performed. The system comprises a location determining system. The location determining system records a movement track of the work machine while the work is being performed. The work data comprise at least the movement track. The system automatically associates the performed work with a class based on the work data. The system is provided and adapted to implement a method according to one of the embodiments described in the preceding.

The system preferably comprises a smartphone. The smartphone can comprise the location determining system. The smartphone can contain a database with a variety of information. The smartphone can associate the work with a class and generate the documentation entry.

Alternatively, the work data can be transmitted to a computer system. The computer system associates the work with a class and generates the documentation entry.

In a preferred embodiment, the work machine has a communication bus, the system can read information from the communication bus, and information from the communication bus is added to the documentation entry by the system at least partially without changes and/or via processing.

Information of the communication bus is information about mounted implements and/or consumed work materials, for example.

In a preferred embodiment, the system is provided and adapted to receive information of radio beacons, and information of the radio beacons is added to the documentation entry by the system at least partially without changes and/or via processing. Radio beacons can be read, for example, by a smartphone associated with the system, or the identification of the radio beacons is read by the work machine and added to the work data. The identification can either be added directly to the work data or information associated with the identification can be read from a database and the information from the database is added to the work data.

### BRIEF DESCRIPTION OF THE DRAWINGS

The invention will be described in more detail in the following referring to an embodiment example. In the drawings,

FIG. 1 shows a recording of a movement track of an agricultural work machine; and

FIG. 2 shows a documentation entry.

### DETAILED DESCRIPTION OF THE EMBODIMENTS

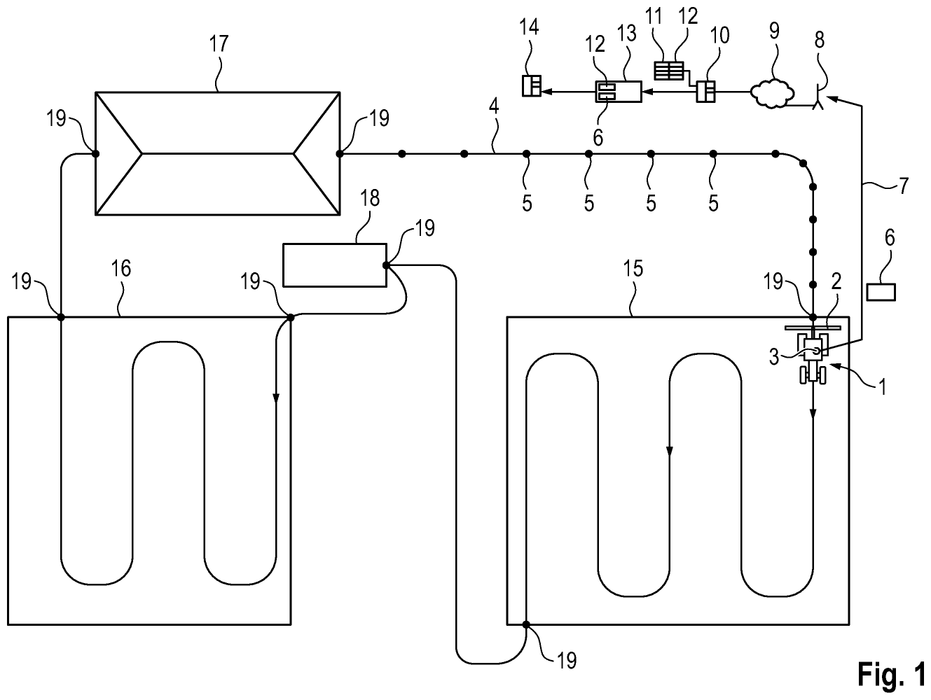

FIG. 1 shows an agricultural work machine 1, in this instance a tractor with a field sprayer as mounted implement 2. The tractor and mounted implement can exchange information via a communication bus. The work machine 1 is outfitted with a location determining system 3. The location determining system 3 records a movement track 4 while the work is being performed. The movement track 4 comprises a sorted list of points 5. Each point 5 indicates a location and is recorded with a timestamp.

The points 5 of the movement track 4 represent work data 6. In this example, the work machine 1 records the consumption of diesel and crop protection means applied with the field sprayer 2 as additional work data 6. The work data 6 are conveyed to a receiver station 8 via a mobile radio link 7. The work data 3 are conveyed from the receiver station 8 to a computer system 10 through a network 9, for example, the Internet.

A database 11 is provided on the computer system 10. The computer system 10 determines the class 12 with which the work is associated from the work data 3 and the information from the database 11. The computer system 10 then generates a documentation entry 13 and enters the class 12 of the work in the documentation entry 13. Additionally, the computer system 10 enters further work data 6 in the documentation entry 13. In this example, the consumption of diesel and crop protection means are entered in the documentation entry 13. The documentation entry 13 is posted in a documentation acquisition system 14.

The computer system calculates the time and the duration of the work from the timestamps of the points 5 of the movement track 4 and enters the time and duration in the documentation entry 13.

The work machine 1 also transmits the type of work machine 1 and the type of mounted implement 2 into the work data 6. The computer system 11 uses this information when associating the work with a class. In addition, the information is added to the documentation entry 13.

The positions of a first field 15 and of a second field 16 are also stored in the database 11. There is also an ID and a name for each field 15, 16 in the database. If the computer system 10 detects that the work was performed in the first field 15 at points 5 of the movement track 4, the computer system 10 adds the ID and the name of the first field 15 to the documentation entry 13.

Locality categories for certain locations, for example, for a farm 17 and a repository 18 of crop protection means, are also stored in the database 11. If the computer system 10 detects that the work machine 1 was in the vicinity of a determined location at points 5 of the movement track 4, the computer system 10 adds the locality category of the location to the documentation entry 13.

The work machine 1 is outfitted with a reading device for radio beacons 19. Radio beacons 19 are arranged at various locations and transmit an identification at regular intervals. When the reading device receives an identification, the identification is added to the work data 6. The computer system 10 detects in the identification the proximity of the work machine 1 to the location where the radio beacon is arranged even if the position of the location is not referenced in the database. A radio beacon 19 is provided, for example, at the repository 18. Further radio beacons are at the entrances to the fields 15, 16 and the farm 17.

Information for the monetary valuation of the work is provided in the database 11. For example, an hourly rate for the work machine 1 is provided. The computer system 10 determines a monetary valuation of the work from the type of work machine, the type of mounted implement and the duration of the work. Prices for work materials such as diesel and crop protection means can also be provided in the database and can be included in the monetary valuation together with the information about consumed work materials.

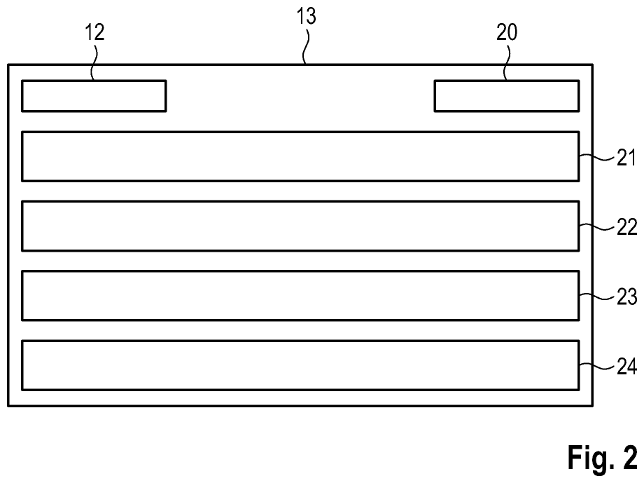

A documentation entry 13 is shown in FIG. 2. The class 12 of the performed work is provided in the documentation entry 13. In addition, the time 20 and the duration of the work are provided. Starting time and ending time of the work can also be provided instead of the duration. The times can be determined from the timestamps of points 5 of the movement track 4. For example, the smallest timestamp of all of the points 4 on a field 15, 16 can be selected as starting time. The largest timestamp of all of the points 4 lying on the same field 15, 16 can be selected as ending time.

The IDs 21 of the worked fields 15, 16 are provided in the documentation entry. Names can also be used instead of IDs. The IDs 21 can be determined from a comparison of the points 5 of the movement track 4 with information about positions of the fields 15, 16 in the database. Alternatively, the fields can be detected via radio beacons 19 at the entrances to the fields 15, 16. The cultivated crop can be noted in the database 11 for each field 15, 16, and the cultivated crop can be inserted in the documentation entry 13 next to the ID.

The consumed work materials 22 are noted in the documentation entry 13. The consumption can be determined by the work machine 1, the mounted implement 2 or the repository 18.

The type 23 of work machine 1 and possibly the type 23 of mounted implement 2 are noted in the documentation entry 13. The type 23 can be added to the work data 6 directly by the work machine 1, or a radio beacon 19 is attached to the work machine 1 and/or mounted implement 2, respectively, and the identification of the radio beacons is read and added to the work data 6. For the identifications of the radio beacons 19, the respective type 23 can be stored in the database 11 and added to the documentation entry 13.

The operator 24 of the work machine 1 is noted in the documentation entry 13. The operator 24 can be noted in the documentation entry as ID and/or as name. The operator can be added manually to the work data 6, or the operator carries a radio beacon 19 and the identification of the radio beacons is read and added to the work data 6. The ID and/or the name of the operator can be stored in the database 11 for the identifications of the radio beacons 19 and added to the documentation entry.

In case information needed for the documentation entry cannot be determined automatically, this information can be added manually by the operator. Should the automatic acquisition be defective, manual correction on the part of the operator is possible. A space for manual amendments can be provided in the documentation entry.

### REFERENCE NUMERALS

1 agricultural work machine
2 mounted implement
3 location determining system
4 movement track
5 location points
6 work data
7 mobile radio link
8 receiver station
9 network
10 computer system
11 database
12 class
13 documentation entry
14 documentation acquisition system
15 first field
16 second field
17 farm
18 repository
19 radio beacon
19 time
21 field ID
22 work materials
23 type of work machine
24 operator

What is claimed is:

1. A method for automatic generation of a documentation that documents work of an agricultural work machine in a documentation entry, the method comprising the following steps:
acquiring work data during performance of the work of the agricultural work machine, the step of acquiring work data including recording a movement track of the work machine with a location determining system, wherein the work data comprise at least the movement track,
automatically associating the performed work with a class based on the acquired work data, and
automatically inserting the class of the performed work in the documentation entry.

2. The method according to claim 1, wherein the documentation entry is entered in a documentation acquisition system.

3. The method according to claim 1, wherein the work data further comprise information about a time and duration of the performed work.

4. The method according to claim 1, wherein information contained in the work data is at least partially inserted in the documentation entry.

5. The method according to claim 1, wherein, when generating the documentation entry, data from a database are inserted into the documentation entry and/or data from the database are used in the step of associating.

6. The method according to claim 5, wherein information from past documentation entries is provided in the database.

7. The method according to claim 5, wherein information about positions for a plurality of fields or a locality category for a plurality of locations or a type of crop grown in at least one field or the class of at least one job previously performed in at least one field is contained in the database.

8. The method according to claim 1, wherein the work data comprise information about mounted implements connected to the work machine, and the information is added to the documentation entry.

9. The method according to claim 1, wherein an amount of work materials which is consumed is determined from the work data, and the consumed amount is added to the documentation entry.

10. The method according to claim 1, wherein the work data comprise information about the movement speed of the work machine at a plurality of points of the movement track.

11. The method according to claim 1, wherein the work data comprise information about a respective orientation of the work machine to a plurality of points of the movement track.

12. The method according to claim 1, wherein a monetary valuation of the performed work is carried out, and the monetary valuation is added to the documentation entry.

13. A system for automatically generating a documentation entry about work performed by an agricultural work machine, comprising a location determining system, wherein the system is configured to
acquire work data during performance of the work of the agricultural work machine,
record a movement track of the work machine with the location determining system, wherein the work data comprise at least the movement track,
automatically associate the performed work with a class based on the acquired work data, and
automatically insert the class of the performed work in the documentation entry.

14. The system according to claim 13, further comprising the agricultural work machine, wherein the work machine has a communication bus, wherein the system is configured to read information from the communication bus, and wherein information from the communication bus is added to the documentation entry by the system at least partially without changes and/or via processing.

15. The system according to claim 13, wherein the system is provided and adapted to receive information of radio beacons, wherein information of the radio beacons is added to the documentation entry by the system at least partially without changes or via processing.
